SEQUENCE LISTING (12 sequences)

SEQ ID NO: 1 - DNA, 18 bp, Artificial Sequence
  Synthetic
gcgaagtgcgggtgattt

SEQ ID NO: 2 - DNA, 27 bp, Artificial Sequence
  Synthetic
gcagtctatgtgtgtttaccgttacct

SEQ ID NO: 3 - DNA, 20 bp, Artificial Sequence
  Synthetic
tgccggttacggttcttttg

SEQ ID NO: 4 - DNA, 27 bp, Artificial Sequence
  Synthetic
tgtcgctgttttctgtgttatctttat

SEQ ID NO: 5 - DNA, 25 bp, Artificial Sequence
  Synthetic
tctaatggcgcttaattatggagat

SEQ ID NO: 6 - DNA, 26 bp, Artificial Sequence
  Synthetic
caactgtcaacaatgtcacttcaaac

SEQ ID NO: 7 - DNA, 21 bp, Artificial Sequence
  Synthetic
aacgccgctctatcattatcg

SEQ ID NO: 8 - DNA, 21 bp, Artificial Sequence
  Synthetic
agcgcaagtcctgattcaaac

SEQ ID NO: 9 - DNA, 26 bp, Artificial Sequence
  Synthetic
gttcttttctttattcccgttttagg

SEQ ID NO: 10 - DNA, 20 bp, Artificial Sequence
  Synthetic
ccggtcttcccattgaaaca

SEQ ID NO: 11 - DNA, 24 bp, Artificial Sequence
  Synthetic
cagcaagggactatttctcacaag

SEQ ID NO: 12 - DNA, 25 bp, Artificial Sequence
  Synthetic
aagcggttttgatggaatgtaataa

(19) United States
(12) Patent Application Publication
(10) Pub. No.: US 2022/0273005 A1
(43) Pub. Date: Sep. 1, 2022

(54) METHOD OF INDUCING BACTERIAL HEAT SENSITIVITY

(71) Applicant: THE STATE OF ISRAEL, MINISTRY OF AGRICULTURE & RURAL DEVELOPMENT, AGRICULTURAL RESEARCH ORGANIZATION, Rishon Lezion (IL)

(72) Inventor: Moshe SHEMESH, Modiin (IL)

(21) Appl. No.: 17/627,799

(22) PCT Filed: Jul. 16, 2020
(86) PCT No.: PCT/IL2020/050802

§ 371 Date: Jan. 17, 2022

Related U.S. Application Data
(60) Provisional application No. 62/874,595, filed on Jul. 16, 2019.

(51) Int. Cl. A23L 3/3553; A23L 3/16; A23L 3/358; A23L 2/46

(52) U.S. Cl. CPC A23L 3/3553; A23L 3/16; A23L 3/358; A23L 2/46; A23V 2002/00

(57) ABSTRACT

The present invention is related to compositions and to methods for pasteurizing a food or beverage products and for sensitizing bacteria to heat treatment. Furthermore, the present invention is related to articles comprising pasteurized food or beverage products.

### CROSS REFERENCE TO RELATED APPLICATIONS

This application claims the benefit of priority of U.S. Provisional patent application No. 62/874,595, filed Jul. 16, 2019, the contents of which are all incorporated herein by reference in their entirety.

### FIELD OF INVENTION

The present invention is directed to a method for improving efficiency of a pasteurization process.

### BACKGROUND OF THE INVENTION

Despite advances in food preservation techniques, bacterial spoilage remains a leading cause of global food loss. Nearly one-third of all food produced worldwide is estimated to be lost postharvest, and much of this loss can be attributed to microbial spoilage. Dairy products constitute one of the leading sectors impacted by food loss, as nearly 20% of conventionally pasteurized fluid milk is discarded prior to consumption each year. Bacterial contamination can adversely affect the quality, functionality and safety of milk and its derivatives. It appears that the major source of the contamination of dairy products is often associated with biofilms on the surfaces of milk processing equipment. Biofilms are highly structured multicellular communities, which allow bacteria to survive under stringent conditions such as: pasteurization at high temperatures and even treatment with alkaline and acidic liquids at high temperatures.

Members of the Bacillus genus are of the most common bacteria found in dairy farms and processing plants. B. cereus forms abundant biofilms on stainless steel, commonly used in food processing plants and contributes to biofouling of processed food. Notably, in a commercial dairy plant B. cereus was found to account for more than 12% of the biofilm constitutive microflora. As Bacillus species are ubiquitously present in nature, they easily spread through food production systems, and contamination with these species is almost inevitable. Moreover, B. cereus spores are both highly resistant to a variety of stresses and very hydrophobic, these features allow them to adhere easily to food processing equipment.

The membrane lipid composition of Bacillus species, specifically B. subtilis is highly variable, and changes according to the state in which the bacteria exist. Among these lipids is the cardiolipin (CL) which makes up to 25% of the membrane composition. CL is a unique phospholipid as it consists of four hydrophobic alkyl groups and carries two hydrophilic negative charges (rather than 2 hydrophobic tails and one hydrophilic head group). These characteristics make CL an important structural and functional unit in the bacterial membrane. As shown by numerous scientific publications, the membrane lipid composition effects the stability of the bacterial membrane. It was demonstrated that the presence of negative intrinsic curvature lipids, such as phosphatidylethanolamine (PE) lipids, potentially destabilizes the bacterial membrane. Furthermore, it was shown, that a PE-knockout mutant strain is much more resistant to the previously mentioned bactericides. All these findings indicate a significant role of the membrane lipid composition for bacterial cell viability.

### SUMMARY OF THE INVENTION

In one aspect of the invention, there is provided a method for sensitizing bacteria to heat treatment, comprising contacting the bacteria with an effective amount of an agent selected from the group consisting of cardiolipin (CL), a cardiolipin synthase (cls) inhibitor, and a cls gene suppressor, or any combination thereof, thereby sensitizing bacteria to heat treatment.

In one embodiment, the cls inhibitor is selected from the group consisting of: distearoylphosphatidate, dimyristoylphosphatidate, (trans-,trans)dioleoylphosphatidate, and dipalmitoylphosphatidate.

In one embodiment, the cls gene suppressor is selected from the group consisting of: an exogenous DNA sequence, a small RNA, a steric block antisense oligonucleotide, a CRISPR/Cas9, and an aptamer, or any combination thereof.

In one embodiment, the agent is a metal salt comprising a metal selected from the group consisting of barium, cobalt, copper, iron, nickel, manganese, zinc, and strontium or any combination thereof.

In one embodiment, the contacting comprises contacting bacteria with a solution comprising an effective concentration of the agent.

In one embodiment, the method further comprises the step of heat-treating the composition, thereby reducing the bacterial load of the composition.

In one embodiment, the reducing is reducing the bacterial load by at least a factor of 10.

In one embodiment, the method further comprises the step of heat-treating the composition, thereby substantially preventing biofilm formation.

In another aspect, provided herein a method for pasteurizing a food or beverage product, comprising the steps of: contacting the product with an effective amount of an agent, wherein the agent is selected from the group consisting of: cardiolipin (CL), surfactin, a cls inhibitor, a cls gene suppressor and a divalent metal cation selected from the group consisting of: barium, cobalt, copper, iron, nickel, manganese, zinc, and strontium or any combination thereof; and pasteurizing the product, thereby producing a pasteurized food product or a beverage.

In one embodiment, the bacteria are of the genus Bacillus.

In another aspect, provided herein is a composition for use in enhancing bacterial heat susceptibility, the composition comprises an agent selected from cardiolipin (CL), a cardiolipin synthase (cls) inhibitor, and a cls gene suppressor or any combination thereof.

In one embodiment, the cls inhibitor is selected from the group consisting of: distearoylphosphatidate, dimyristoylphosphatidate, (trans-,trans)dioleoylphosphatidate, and dipalmitoylphosphatidate.

In one embodiment, the cls gene suppressor is a cls gene expression suppressor selected from the group consisting of: an exogenous DNA sequence, a small RNA, a steric block antisense oligonucleotide, a CRISPR/Cas9, and an aptamer, or any combination thereof.

In one embodiment, the agent comprises or is a metal salt, wherein the metal is selected from the group consisting of barium, cobalt, copper, iron, nickel, manganese, zinc, and strontium or any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1A-1B: Creation of cardiolipin synthase (cis) mutants. A. Verification of deletion strains—ΔclsA and ΔclsB were created on the background of NCIB 3610 wt strain. The deletions were verified through PCR. B. wt, ΔclsA and ΔclsB strains were diluted to an OD₆₀₀ of 0.1, and the OD of the different strains was measured every hour.

FIGS. 2A-2D: ΔclsA is more sensitive to heat treatment. A. The resistance of the mutants to heat treatment was tested by the CFU counting method. The strains were exposed to 60° C. for 30 minutes and the number of bacteria that survived was tested. B-D. non-limiting schematic deception of the suggested model. B. wt membrane without Mg²⁺ ions is stable. C. Mg²⁺ ions interact with the cardiolipin (CL) found in the w.t. membrane and destabilize it. D. The ΔclsA membrane is unstable due to the loss of CL.

FIG. 3: ΔclsA and ΔclsB mutants are not capable of creating a biofilm. The ability of the mutants to form three types of biofilms was tested: (i) colony type—in the interface between solid and air, (ii) pellicle—in the interface between liquid and air, and (iii) bundles—in an aqueous interface.

FIG. 4: Matrix producing genes are not expressed in the ΔclsA and ΔclsB mutants. The relative expression levels of epsH and tasA were measured by Real-Time PCR. The results presented above represent an average of three biological repeats.

FIG. 5A-5C Providing extracellular cardiolipin interferes with normal biofilm formation. Ten-fold serial dilutions of CL were added to the medium and bacteria were grown. FIG. 5A: a microgram showing pellicle formation of NCIB 3610 strain after 18 h. FIG. 5B: a microgram showing bundle formation of YC189 strain after 12 h. FIG. 5C: a microgram showing bundle formation of YC189 strain after 18 h. Control—Medium without any addition, 0-100 uM CL—CL diluted in chloroform (final concentration of chloroform was 0.2%).

FIG. 6. Combination of extracellular cardiolipin (CL) and surfactin reduces biofilm formation.

### DETAILED DESCRIPTION OF THE INVENTION

The present invention, in some embodiments thereof, is directed to a method for reducing bacterial contamination within a liquid, comprising the steps of adding an effective amount of any of a cardiolipin synthase (cls) inhibiting agent, and a cls gene suppressing agent to the liquid; and heat-treating the liquid, thereby reducing bacterial contamination within a liquid.

The invention is further directed to a method for sensitizing bacteria to heat treatment by reducing cardiolipin (CL) concentration within bacterial membrane, the method comprises administering an effective amount of an agent as described herein, to the contaminated liquid. According to some embodiments, the concentration of CL is reduced by suppressing cardiolipin synthase (cls) gene.

The present invention is based, in part, on the finding that Δcls of B. subtilis has reduced expression levels of matrix producing genes (epsH and tasA), thus resulting in impaired ability of the mutants to form biofilm. The invention is also based, in part, on the finding, that Δcls mutants are more sensitive to heat treatment. These finding reveal the role of CL in stabilizing the bacterial membrane, thus promoting bacterial resistance to heat treatment.

Thus, the present invention provides a method for reducing bacterial contamination and biofilm formation within a liquid and on a surface, by altering membrane lipid composition of bacterial cells.

Also, provided herein is a method for producing a pasteurized food or beverage product by adding a composition comprising an effective amount of an agent as described herein to the food product or beverage; and heat treating the food or beverage product.

### Heat Sensitized Bacteria

According to some aspects, the present invention provides a method for sensitizing bacteria to heat treatment, by administering a composition comprising an effective amount of a cls inhibiting or a cls gene suppressing agent to bacterial cells, to obtain heat sensitive bacteria.

A skilled artisan will appreciate that an effective concentration may depend on a specific use of the composition, such as for providing a composition either to a liquid or to a surface.

In some embodiments, the method for sensitizing bacteria to heat treatment comprises providing an effective amount of a cls inhibiting or a cls gene suppressing agent to a liquid containing bacteria. In some embodiments, a method for sensitizing bacteria to heat treatment comprises providing an effective amount of the agent to a liquid suspected of containing bacteria. In some embodiments, the method comprises providing a composition comprising an effective amount of the agent to the liquid.

In some embodiments, the method is for enhancing bacterial heat susceptibility, the method comprising contacting the composition comprising an agent selected from cardiolipin (CL), surfactin, a cardiolipin synthase (cls) inhibitor, and a cls gene suppressor or any combination thereof with a bacterial cell; thereby obtaining the bacterial cell characterized by an enhanced bacterial heat susceptibility. In some embodiments, the term “enhancing” in any grammatic form thereof is as described hereinbelow.

In some embodiments, the final concentration of the agent in the liquid ranges from 0.1 μM to 1 μM, from 1 μM to 5 μM, from 5 μM to 10 μM, 5 μM to 50 μM, 5 μM to 25 μM, 5 μM to 100 μM, 5 μM to 200 μM, 5 μM to 500 μM, 10 μM to 50 μM, 10 μM to 100 μM, 10 μM to 200 μM, 10 μM to 500 μM, 50 μM, to 100 μM, 50 μM to 200 μM, 50 μM to 500 μM, 100 μM to 200 μM, 100 μM to 300 μM, 100 μM to 500 μM, or 100 μM to 1000 μM. Each possibility represents a separate embodiment of the present invention.

In some embodiments, the method for sensitizing bacteria to heat treatment comprises providing a composition comprising an effective amount of the agent to a surface containing bacteria. In some embodiments, the method for sensitizing bacteria to heat treatment comprises providing a composition comprising an effective amount of the agent to a surface suspected of containing bacteria.

The term “sensitizing”, as used herein, refers to a method for inducing bacterial vulnerability to heat treatment.

In some embodiments, the agent is capable of (i) reducing biofilm formation, (ii) inducing heat-sensitivity of a bacteria or both. In some embodiments, the agent is capable of blocking or inhibiting any cell signaling leading to the formation of matrix proteins and/or to the formation of biofilm.

In some embodiments, the agent is selected from the group consisting of a lipid, cardiolipin (CL), surfactin, a cardiolipin synthase (cls) inhibitor, a cls gene suppressor, and a divalent metal cation selected from the group consisting of barium, cobalt, copper, iron, nickel, manganese, zinc, and strontium, including any salt or any combination thereof. In some embodiments, the agent is selected from the group consisting of a cls inhibitor, and a cls gene suppressor. In some embodiments, the agent is a divalent metal cation selected from the group consisting of barium, cobalt, copper, iron, nickel, manganese, zinc, and strontium, or any combination thereof.

In some embodiments, the agent is a lipid, wherein the lipid is capable of inducing structural changes within a bacterial membrane. In some embodiments, the lipid is capable of interacting or binding bacterial CL. In some embodiments, the lipid is capable of destabilizing a bacterial membrane. In some embodiments, the lipid is capable of displacing CL from the bacterial membrane.

In some embodiments, the agent is a phospholipid. In some embodiments, the agent is a phosphatidylglycerol. In some embodiments, the agent is a diphosphatidylglycerol lipid. In some embodiments, the agent is CL. In some embodiments, the agent is a combination of CL and surfactin. In some embodiments, the agent is a combination of CL and a divalent metal cation selected from the group consisting of magnesium, barium, cobalt, copper, iron, nickel, manganese, zinc, and strontium, or any combination thereof. In some embodiments, the agent is a magnesium salt of CL, and optionally in a combination with surfactin. In some embodiments, the agent (e.g. CL and/or surfactin) prevents or reduces binding of surfactin to the membrane of bacteria. In some embodiments, the agent (e.g. CL and/or surfactin) prevents or reduces surfactin-induced biofilm formation.

In some embodiments, the agent comprises a combination of CL and surfactin, wherein a molar ratio of CL to surfactin is between 10:1 and 1:10, between 10:1 and 5:1, between 5:1 and 2:1, between 2:1 and 1:1, between 1:1 and 1:2, between 1:2 and 1:5, between 1:5 and 1:10, including any range or value therebetween.

In some embodiments, heat sensitized bacteria exhibit structural changes within the membrane. In some embodiments, heat sensitized bacteria exhibit destabilization of the membrane. In some embodiments, heat sensitizing results in reduction and/or inhibition of bacterial cls activity. In some embodiments, heat sensitizing results in reduction and/or inhibition of bacterial cls gene expression. In some embodiments, heat sensitizing results in reduction and/or inhibition of cardiolipin (CL) concentration within the bacterial membrane. In some embodiments, heat sensitizing comprises cation-CL complex formation, inducing conformational changes in bacterial CL. In some embodiments, bacteria with reduced CL content are more vulnerable to heat treatment. In some embodiments, bacteria exhibiting conformational changes in bacterial CL are more vulnerable to heat treatment. In some embodiments, the membrane with reduced CL content has an impaired fluidity. In some embodiments, bacteria with reduced CL content.

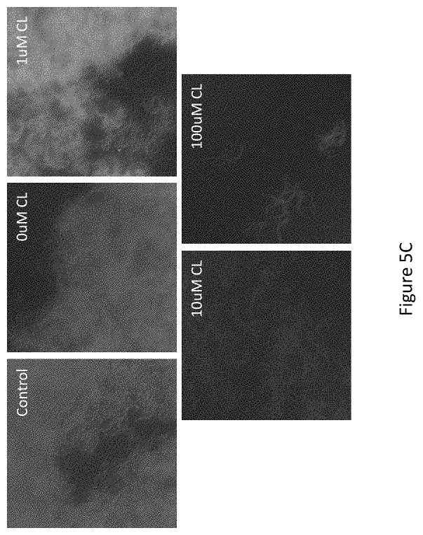

In some embodiments, the method is for reducing or inhibiting biofilm formation. In some embodiments, heat sensitized bacteria have a reduced ability to form biofilm. In some embodiments, biofilms comprising heat sensitized bacteria have a reduced ability to survive heat treatment. In some embodiments, heat sensitized bacteria are characterized by a delayed biofilm formation (see FIG. 5). In some embodiments, biofilms comprising heat sensitized bacteria can be eliminated by heat treatment. In some embodiments, biofilms comprising heat sensitized bacteria can be reduced by heat treatment. In some embodiments, biofilm formation can be reduced by heat-sensitizing bacteria. In some embodiments, biofilm formation can be prevented by heat-sensitizing bacteria. In some embodiments, heat sensitized bacteria does not express matrix producing genes (tasA and epsH). Matrix producing genes are responsible for the synthesis of extracellular matrix—a key step in the process of biofilm formation.

### CLS Suppressors

In some embodiments, the agent is a cls gene suppressor.

Non-limiting examples of gene suppressors include, but are not limited to exogenous DNA sequence, small RNAs, antisense oligonucleotide (ASO), steric block ASO, CRISPR/Cas9, and aptamers or any combination thereof. The term “small RNA”, as used herein refers to short non-coding RNA molecules, including but not limited to microRNAs (miRNAs), small interfering RNAs (siRNAs), small nuclear RNAs (snRNAs), small nucleolar RNAs (snoRNAs), small temporal RNAs (stRNAs), antigene RNAs (agRNAs), piwi-interacting RNAs (piRNAs) and other short-regulatory nucleic acids. In some embodiments, the cls gene suppressor has a sequence complementary to one or more regions within the cls protein. In some embodiments, the agent is a compound capable of hybridizing the cls gene or a transcript thereof, thereby reducing, silencing or inhibiting the expression of the cls gene.

Methods for determining levels of gene expression (e.g., following reduction, silencing or inhibition) are common and would dbe apparent to one of ordinary skill in the art of molecular biology. Non-limiting examples for such methods include, but are not limited to, RT-PCR, real time RT-PCR, western blot, or others.

In some embodiments, there is provided a method for generating heat sensitized bacteria, comprising administering an effective amount of a cls gene suppressor to bacterial cells.

In some embodiments, the method comprises adding a composition comprising a cls gene suppressor.

In some embodiments, the method comprises adding a source of a cls gene suppressor to the liquid to achieve a final concentration of the cls gene suppressor in the liquid ranging from 1 μM to 1000 μM.

In some embodiments, the final concentration of the cls gene suppressor in the liquid ranges from from 0.1 μM to 1 μM, from 1 μM to 5 μM, from 1 μM to 10 μM, 5 μM to 50 μM, 5 μM to 25 μM, 5 μM to 100 μM, 5 μM to 200 μM, 5 μM to 500 μM, 10 μM to 50 μM, 10 μM to 100 μM, 10 μM to 200 μM, 10 μM to 500 μM, 50 μM, to 100 μM, 50 μM to 200 μM, 50 μM to 500 μM, 100 μM to 200 μM, 100 μM to 300 μM, 100 μM to 500 μM, or 100 μM to 1000 μM. Each possibility represents a separate embodiment of the present invention.

In some embodiments, the method is directed to a composition comprising an effective amount of the cls gene suppressor as an active ingredient, and an acceptable carrier and/or diluent. The composition may contain an additional component (e.g. nano-particles, liposomes, coloring agents, food additives). In some embodiments, an additional component stabilizes the active ingredient and/or prevents degradation of the active ingredient. In some embodiments, an additional component improves a bioavailability and/or bioaccessibility of the active ingredient.

In some embodiments, the present invention provides a method for reducing CL concentration within bacterial membrane, comprising administering an effective amount of the cls gene suppressor to bacterial cells. In some embodiments, the suppressor inhibits and/or reduces expression of the bacterial cls gene.

In some embodiments, there is provided a method for reducing and/or preventing bacterial cls gene translation, comprising administering an effective amount of the cls gene suppressor to bacterial cells. In some embodiments, the present invention provides a method for reducing and/or preventing bacterial cls gene transcription, comprising administering an effective amount of the cls gene suppressor to bacterial cells.

In some embodiments, there is provided a method for inducing mutations to bacterial strains. In some embodiments, there is provided a method for inducing deletion mutations of bacterial cls gene. According to some embodiments, the chromosomal cls gene (comprising two major forms: clsA and clsB) may be deleted by an appropriate knock-out mutation technique, which is known to those skilled in the art. “Knock-out mutation” as used herein refers to an engineered disruption of native chromosomal DNA, typically within a protein coding region, such that a foreign piece of DNA is inserted within the native sequence. A non-limiting detailed description is provided in Example 1. In some embodiments, a knock-out mutation prevents expression of the wild-type bacterial cls, leading to CL depletion within bacterial membrane.

### Cls Inhibitors

In some embodiments, the agent is a cls inhibitor.

As used herein, the term “cls inhibitor” encompasses any compound that reduces or deactivates bacterial cls enzyme activity.

Non-limiting examples of cls inhibitors include, but are not limited to: antimicrobial peptides (e.g. gramicidin, nisin, valinomycin, bacitracin, microcystin, nonactin); lipopeptides (e.g. surfactin, iturin, polymyxin, antimycin, syringomycin), macrolide polyenes (e.g. nystatine, amphotericin, filipin), polyamines, di stearoylphosphatidate, dimyristoylphosphatidate, (trans-,trans-)dioleoylphosphatidate, and dipalmitoylphosphatidate or any combination thereof.

In some embodiments, the cls inhibitor has a sufficient binding affinity to one or more regions within the cls protein. In some embodiments, sufficient affinity is so as to reduce and/or inhibit enzymatic activity of the cls. In some embodiments, the cls inhibitor is a compound capable of binding the cls protein, thereby reducing, silencing or inhibiting the biological activity (e.g. enzymatic activity) of the cls.

It should be understood that the enzymatic activity can be estimated by using any one of the methods known in the art.

In some embodiments, there is provided a method for reducing bacterial cardiolipin (CL) concentration within bacterial membrane, comprising administering an effective amount of the cls inhibitor to bacterial cells. In some embodiments, the cls inhibitor inhibits and/or reduces the enzymatic activity of bacterial cls.

In some embodiments, there is provided a method for generating heat sensitized bacteria, comprising administering an effective amount of the cls inhibitor to bacterial cells.

In some embodiments, the method comprises adding a composition comprising a cls inhibitor.

In some embodiments, the method comprises adding a source of a cls inhibitor to the liquid to achieve a final concentration of the cls inhibitor in the liquid ranging from 1 μM to 1000 μM.

In some embodiments, the final concentration of the cls inhibitor in the liquid ranges from 0.1 μM to 1 μM, from 1 μM to 5 μM, from 5 μM to 10 μM, 5 μM to 50 μM, 5 μM to 25 μM, 5 μM to 100 μM, 5 μM to 200 μM, 5 μM to 500 μM, 10 μM to 50 μM, 10 μM to 100 μM, 10 μM to 200 μM, 10 μM to 500 μM, 50 μM to 100 μM, 50 μM to 200 μM, 50 μM to 500 μM, 100 μM to 200 μM, 100 μM to 300 μM, 100 μM to 500 μM, or 100 μM to 1000 μM. Each possibility represents a separate embodiment of the present invention.

In some embodiments, the method is directed to a composition comprising an effective amount of the cls inhibitor as an active ingredient, and an acceptable carrier and/or diluent. The composition may contain an additional component (e.g. nano-particles, liposomes, coloring agents, food additives). In some embodiments, an additional component stabilizes the active ingredient and/or prevents degradation of the active ingredient. In some embodiments, an additional component improves a bioavailability and/or bioaccessibility of the active ingredient.

### Metal Cations

In some embodiments, the agent is a divalent metal cation.

In some embodiments, the divalent metal cation is selected from the group consisting of: barium-, calcium-, cobalt-, copper-, iron-, nickel-, manganese-, zinc-, and strontium (II) cations or any combination thereof. In some embodiments, the agent is substantially devoid of magnesium (II) cations. In some embodiments, the agent is a salt comprising the divalent metal cation. In some embodiments, the salt is a food-acceptable salt.

In some embodiments, the agent (e.g. divalent metal cation) is capable of binding to CL (e.g. bacterial CL). In some embodiments, binding is via a covalent bond. In some embodiments, the agent (e.g. divalent metal cation) is capable of structurally destabilizing CL within the bacterial membrane. In some embodiments, the agent (e.g. divalent metal cation) is capable of structurally destabilizing CL, so as to result in a formation of a heat sensitized bacteria. In some embodiments, the agent is capable of complexing the CL (e.g. bacterial CL).

In some embodiments, there is provided a method for producing heat sensitized bacteria, comprising administering an effective amount of a divalent metal cation to bacterial cells. In some embodiments, the method comprises administering an effective amount of a divalent metal cation to bacterial cells, for inducing cation-CL complex formation. In some embodiments, cation-CL complexes induce structural changes within bacterial membrane. In some embodiments, cation-CL complexes impaired fluidity of the bacterial membrane. In some embodiments, cation-CL complexes destabilize bacterial membrane, thus reducing bacterial heat resistance. In some embodiments, bacteria comprising cation-CL complexes are sensitized to heat treatment.

In some embodiments, the method comprises adding a composition comprising a divalent metal cation.

In some embodiments, the method comprises adding a source of a divalent metal cation to the liquid to achieve a final concentration of the divalent metal cation in the liquid ranging from 1 mM to 1000 mM.

In some embodiments, the final concentration of the divalent metal cation in the liquid ranges from 0.1 μM to 1 μM, from 1 μM to 5 μM, 5 mM to 10 mM, 5 mM to 50 mM, 5 mM to 25 mM, 5 mM to 100 mM, 5 mM to 200 mM, 5 mM to 500 mM, 10 mM to 50 mM, 10 mM to 100 mM, 10 mM to 200 mM, 10 mM to 500 mM, 50 mM to 100 mM, 50 mM to 200 mM, 50 mM to 500 mM, 100 mM to 200 mM, 100 mM to 300 mM, 100 mM to 500 mM, or 100 mM to 1000 mM. Each possibility represents a separate embodiment of the present invention.

In some embodiments, the method is directed to a composition comprising an effective amount of the divalent metal cation as an active ingredient, and an acceptable carrier and/or diluent. The composition may contain an additional component (e.g. nano-particles, liposomes, coloring agents, food additives). In some embodiments, an additional component improves a bioavailability and/or bioaccessibility of the active ingredient.

In some embodiments, the source of a divalent cation is an aqueous solution of an ionic compound. In some embodiments, a divalent cation is added in a form of an ionic compound (e.g. inorganic salt). Ionic compound as used herein, comprise the above described divalent cations and counter anions.

Non-limiting examples of counter anions include but are not limited to: chloride, fluoride, sulfate, nitrate, acetate, carbonate, citrate, phosphate or hydrates thereof.

Alternatively, the source of a divalent cation may be a nanoparticle comprising divalent cations. In some embodiment, the source of a divalent cation are capsules with antifouling properties which are spherical particles that can entrap and release different molecules. For a non-limiting example, the particles may be generated through a self-assembly of an antifouling peptide such as disclosed in Maity et al., Chemical communications (2014) 50, 11154-11157. In one embodiment, the source of a divalent cation are capsules that contain divalent cations and can release divalent cations.

### Heat Treatment

In some embodiments, there is provided a method of heat-sensitizing a bacterial load of a composition, comprising pretreating a composition suspected of containing the bacterial load by contacting the composition with an effective amount of the agent, as described herein.

In some embodiments, the method comprises administering a composition comprising an effective amount of the agent to the liquid. In some embodiments, the method is for pretreating the liquid, thereby obtaining a pretreated liquid. In some embodiments, the pretreated liquid is suitable for heat treatment.

In some embodiments, the method further comprises a step of heat treating the pretreated liquid, wherein the heat treatment refers to a method of sterilizing liquid food products comprising heating the liquid product to a desired temperature. In some embodiments, the heat treatment refers to pasteurization of the liquid.

In some embodiments, there is provided a method for controlling bacterial load within a liquid (e.g. beverage), comprising: administering an efficient amount of the agent to the liquid, thereby obtaining a pretreated liquid; and heat treating the pretreated liquid.

In some embodiments, the method is for improving efficiency of liquid pasteurization.

In some embodiments, there is provided a method for improving heat-treatment effectiveness of a food product, comprising pretreating a food product suspected of containing bacteria by contacting a food product with an effective amount of the agent, thereby obtain a food product comprising heat-sensitized bacteria. In some embodiments, the method further comprises heat-treating the food product. In some embodiments, the method is for manufacturing a heat-treated food product.

As defined herein, the term “controlling” is related to reduction of colony forming unit (CFU)/milliliter within a heat-treated liquid or a heat-treated food product as compared to non-pretreated food product. In some embodiments, the method of the invention comprises reduction of CFU/milliliter within a heat-treated liquid or a heat-treated food product at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10.000, at least by a factor of 50.000, at least by a factor of 100.000, at least by a factor of 1000.000, as compared to a non-pretreated food product including any range or value therebetween.

The term “pasteurization” refers in this context to heating of the substance (e.g. beverage) typically at a temperature between 72 and 95° C. for 20 to 60 seconds, for instance at least at a temperature of 72° C. for 15 seconds. Pasteurization reduces or eliminates heat-sensitive microorganisms that can spoil the food or that are pathogens or spoilage microorganisms. Heat-sensitive microorganism are defined as being microorganisms that are substantially killed by the pasteurization process.

In contrast to pasteurization, sterilization of foods is meant to kill all microorganisms including heat-resistant microorganisms. Sterilization of foods is performed by heating the food to higher temperatures than pasteurization.

The term “heat treatment”, as used herein, refers to any process of applying heat for killing or inactivating microorganisms in a food product. In some embodiments, heat treatment comprises any thermal processing of food (e.g. pasteurization and/or sterilization).

In some embodiments, the food product is selected from the group consisting of: milk products, non-dairy products, milk, dairy beverages, and non-dairy beverages.

In some embodiments, the liquid is a non-dairy beverage or a non-dairy beverage product.

As used herein the term “non-dairy” include all types of products that contain no milk or milk products from a mammalian source. As used herein the term “beverage” refers to a substantially aqueous drinkable composition suitable for human consumption. Non-limiting examples of beverages include water, soft drinks, juice based on fruit extracts, juice based on vegetable extracts, plant milk (e.g., soymilk, almond milk, rice milk, coconut milk etc.), coffee, tea, and any combination thereof.

Non-limiting examples of fruit extracts include extracts from mango, pomegranate, passion fruit, berries, watermelon, strawberry, plum, pear, grape, guava, grapefruit, lemon, tangerine, papaya, pineapple, apple, cranberry, banana, orange or any combinations thereof.

Non-limiting examples of vegetable extracts include extracts from carrot, tomato, beetroot or any combinations thereof. The extracts can be in the form of juices, pulps or any combinations thereof, which goes into making of the beverages.

In some embodiments, the liquid is a milk and/or a milk product.

As used herein, the term ‘milk’ refers to any normal secretion obtained from the mammary glands of mammals, such as human's, cow's, goat's, horse's, camel's, pig's, buffalo's or sheep's milk, and includes milk, whey, combinations of milk and whey as such or as a concentrate, and the various milk products produced therefrom. Milk typically comprises whey proteins and caseins. The ratio between whey proteins and caseins may differ between different species. For example, the protein content of cow's milk includes 20% whey proteins and 80% caseins, whereas the protein content of human's milk includes 60% whey proteins and 40% caseins.

As used herein the term “whey proteins” refers to a mixture of globular proteins. There are many whey proteins in milk and the specific set of whey proteins found in mammary secretions varies with the species, as well as other factors. The major whey proteins in cow's milk are ß-lactoglobulin and a-lactalbumin. As used herein, the term “casein” refers to αₛ₁-casein, αₛ₁-casein, β-casein, κ-casein or the combination thereof as present in milk of mammals, the different caseins are distinct molecules but are similar in structure. The different caseins are found in milk as a suspension of particles, i.e., casein micelles. The term “casein”, as used herein, further encompasses acid casein, rennet casein, hydrolyzed casein, sodium caseinate, potassium caseinate, magnesium caseinate, calcium caseinate, and combinations thereof.

In some embodiments, the mammal is selected from the group consisting of: sheep, cow, goat, camel, buffalo, pig, and a horse. In some embodiments, the mammal is a cow. In some embodiments, the milk is a cow's milk. In some embodiments, the milk is a human's milk.

The milk may be supplemented with ingredients generally used in the preparation of milk products, such as fat, protein or sugar-fractions, or the like. The milk thus includes, for example, full-fat milk, low-fat milk, skim milk, delectated milk, cream, ultrafiltered milk, diafiltered milk, micro-filtered milk, milk recombined from milk powder, condensed milk, powder milk organic milk or a combination or dilution of any of these.

As used herein the term “milk product” refers to a product derived from any processing of milk. The term “milk product” further encompasses fermented milk products. Non-limiting examples of fermented milk products include yoghurt, kefir, curd cheese, curd, buttermilk, butter, fresh cheese and semi-solid cheese. In some embodiments, the milk product is cheese.

### Biofilm

In some embodiments, there is provided a method for preventing biofilm formation. In some embodiments, there is provided a method for inhibiting biofilm formation. In some embodiments, there is provided a method for reducing existing biofilms. In some embodiments, there is provided a method for breaking-down existing biofilms.

In some embodiments, the method comprises contacting a food product with an efficient amount of the agent, thereby preventing and/or inhibiting biofilm formation. In some embodiments, the method comprises contacting the food product with a composition, comprising an efficient amount of the agent, wherein the agent is as defined hereinabove. In some embodiments, the method further comprises heat treating the food article, thereby reducing and/or breaking-down existing biofilms.

In some embodiments, the method comprises pretreating the food product by contacting the food product with a composition, comprising an efficient amount of the agent. In some embodiments, the method comprises pretreating the food article, thereby obtaining a pretreated food article. In some embodiments, the pretreated food product is suitable for heat treatment. In some embodiments, the method further comprises heat treating the food article, thereby reducing and/or breaking-down existing biofilms.

As used herein the term “biofilm” refers to any three-dimensional, matrix-encased microbial community displaying multicellular characteristics. Accordingly, as used herein, the term biofilm includes surface-associated biofilms as well as biofilms in suspension, such as flocs and granules. Biofilms may comprise a single microbial species or may be mixed species complexes, and may include bacteria, or other microorganisms.

As used herein, the term “reducing” in any grammatic form thereof, is related to reduction of any type of biofilms (e.g. pellicle, bundle) within a pretreated liquid or a pretreated food product, as compared to non-pretreated liquid or food product. In some embodiments, the biofilm is essentially nullified or is reduced by at least 20%, at least 30%, at least 40%, at least 50%, at least 60%, at least 70%, at least 80%, at least 90%, including any value therebetween.

In some embodiments, the biofilm comprises bacteria. In some embodiments, the bacteria are selected from: Gram positive bacteria and Gram-negative bacteria. In some embodiments, the biofilm comprises bacteria. In some embodiments, the bacteria are Gram positive bacteria. In some embodiments, the bacteria are Gram negative bacteria. In some embodiments, the bacteria are spore forming bacteria. In some embodiments, the bacteria are thermophilic bacteria. The terms “bacteria” and “bacterium” refer to all prokaryotic organisms, including those within all of the phyla in the Kingdom Procaryotae. It is intended that the term encompass all microorganisms considered to be bacteria including Mycoplasma, Chlamydia, Actinomyces, Streptomyces, and Rickettsia. All forms of bacteria are included within this definition including cocci, bacilli, spirochetes, spheroplasts, protoplasts, etc.

In some embodiments, the bacteria are of the genus bacillus. In some embodiments, the bacteria are selected from the bacteria strains Bacillus cereus, Bacillus licheniformis and Bacillus subtilis.

### Disinfectant

In another aspect, there is a composition for use in enhancing bacterial heat susceptibility, the composition comprising an agent selected from cardiolipin (CL), surfactin, a cardiolipin synthase (cls) inhibitor, and a cls gene suppressor or any combination thereof. In some embodiments, the composition is the composition of the invention. In some embodiments, the composition is a bactericidal composition. In some embodiments, the composition is in a form of a liquid, a solid, a semi-solid, or a semi-liquid, or any combination thereof.

In some embodiments, enhancing is by at least 20%, at least 30%, at least 40%, at least 50%, at least 60%, at least 70%, at least 80%, at least 90%, at least 100%, at least 200%, at least 300%, at least 500%, at least 1000%, at least 5000%, at least 10.000%, at least 100.000%, at least 1000.000%, compared to a non-treated composition, including any range or value therebetween.

The present invention further relates to a disinfectant comprising an effective concentration of an agent, wherein the agent is as defined herein above. A skilled artisan will appreciate that an effective concentration may depend on a specific use of the disinfectant. In some embodiments, the term “disinfectant” and the term “bactericidal composition” and/or the term “composition” are used herein interchangeably.

The present invention further relates to a disinfectant comprising a cls gene suppressor at a concentration ranging from 1 mM to 1000 mM. In some embodiments, the concentration of a cls gene suppressor in the disinfectant ranges from 5 mM to 10 mM, 5 mM to 50 mM, 5 mM to 100 mM, 5 mM to 150 mM, 5 mM to 200 mM, 5 mM to 500 mM, 10 mM to 50 mM, 10 mM to 100 mM, 10 mM to 150 mM, 10 mM to 200 mM, 10 mM to 500 mM, 20 mM to 50 mM, 20 mM to 100 mM, 20 mM to 150 mM, 20 mM to 200 mM, 20 mM to 500 mM, 30 mM to 50 mM, 30 mM to 100 mM, 30 mM to 150 mM, 30 mM to 200 mM, 30 mM to 500 mM, 50 mM to 100 mM, 50 mM to 150 mM, 50 mM to 200 mM, 50 mM to 500 mM, 100 mM to 150 mM, 100 mM to 200 mM, 100 mM to 300 mM, 100 mM to 500 mM, or 100 mM to 1000 mM. Each possibility represents a separate embodiment of the present invention. The present invention further relates to a disinfectant comprising a cls gene suppressor at a concentration of at least 1 mM, 2mM, 3mM, 5 mM, 10 mM, 15 mM, 20 mM, 25 mM, 30 mM, 35 mM, 40 mM, 45 mM, 50 mM, 55 mM, 60 mM, 65 mM, 70 mM, 80 mM, or 100 mM.

The present invention further relates to a disinfectant comprising a cls inhibitor at a concentration ranging from 1 mM to 1000 mM. In some embodiments, the concentration of a cls inhibitor in the disinfectant ranges from 5 mM to 10 mM, 5 mM to 50 mM, 5 mM to 100 mM, 5 mM to 150 mM, 5 mM to 200 mM, 5 mM to 500 mM, 10 mM to 50 mM, 10 mM to 100 mM, 10 mM to 150 mM, 10 mM to 200 mM, 10 mM to 500 mM, 20 mM to 50 mM, 20 mM to 100 mM, 20 mM to 150 mM, 20 mM to 200 mM, 20 mM to 500 mM, 30 mM to 50 mM, 30 mM to 100 mM, 30 mM to 150 mM, 30 mM to 200 mM, 30 mM to 500 mM, 50 mM to 100 mM, 50 mM to 150 mM, 50 mM to 200 mM, 50 mM to 500 mM, 100 mM to 150 mM,100 mM to 200 mM, 100 mM to 300 mM, 100 mM to 500 mM, or 100 mM to 1000 mM. Each possibility represents a separate embodiment of the present invention. The present invention further relates to a disinfectant comprising a cls inhibitor in a concentration of at least 5 mM, 10 mM, 15 mM, 20 mM, 25 mM, 30 mM, 35 mM, 40 mM, 45 mM, 50 mM, 55 mM, 60 mM, 65 mM, 70 mM, 80 mM, or 100 mM.

The present invention further relates to a disinfectant comprising a divalent metal cation at a concentration ranging from 1 mM to 1000 mM. In some embodiments, the concentration of divalent metal cations in the disinfectant ranges from 5 mM to 10 mM, 5 mM to 50 mM, 5 mM to 100 mM, 5 mM to 150 mM, 5 mM to 200 mM, 5 mM to 500 mM, 10 mM to 50 mM, 10 mM to 100 mM, 10 mM to 150 mM, 10 mM to 200 mM, 10 mM to 500 mM, 20 mM to 50 mM, 20 mM to 100 mM, 20 mM to 150 mM, 20 mM to 200 mM, 20 mM to 500 mM, 30 mM to 50 mM, 30 mM to 100 mM, 30 mM to 150 mM, 30 mM to 200 mM, 30 mM to 500 mM, 50 mM to 100 mM, 50 mM to 150 mM, 50 mM to 200 mM, 50 mM to 500 mM, 100 mM to 150 mM, 100 mM to 200 mM, 100 mM to 300 mM, 100 mM to 500 mM, or 100 mM to 1000 mM. Each possibility represents a separate embodiment of the present invention. The present invention further relates to a disinfectant comprising metal cations in a concentration of at least 5 mM, 10 mM, 15 mM, 20 mM, 25 mM, 30 mM, 35 mM, 40 mM, 45 mM, 50 mM, 55 mM, 60 mM, 65 mM, 70 mM, 80 mM, or 100 mM.

In some embodiments, the disinfectant is an aqueous solution or a colloid solution. In one embodiment, the disinfectant is in a form of a foam or a spray. In one embodiment, the disinfectant is in a form of a cream.

In some embodiments, the disinfectant is for use in a method for treating, preventing, inhibiting, and/or reducing biofilm formation and/or reducing or breaking-down existing biofilms on a surface. In some embodiments, the disinfectant is for use in reducing an amount of bacterial biofilm formation on a surface. In another embodiment, the disinfectant is for use in cleaning machines in the food industry. In some embodiments, the biofilm is formed by bacteria. In some embodiments, populations of the bacteria may be treated by the disinfectant prior to, during, and/or after biofilm formation.

In some embodiments, there is provided a method for treating, preventing, inhibiting, and/or reducing biofilm formation and/or reducing or breaking-down existing biofilms on the surface, the method comprises the step of applying a composition comprising an effective concentration of the agent onto the surface, thereby treating, preventing, inhibiting, and/or reducing biofilm formation and/or reducing or breaking-down existing biofilms on the surface.

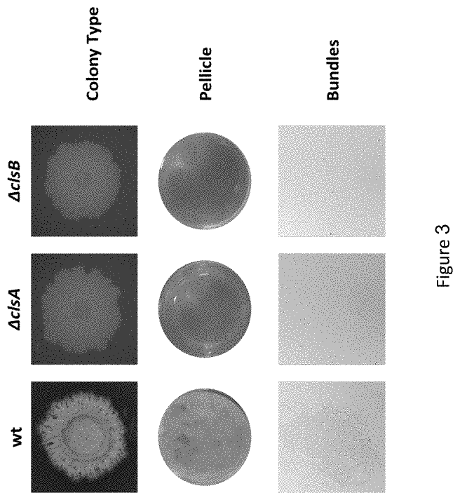

As exemplified by FIG. 3, B. subtilis treated by the disinfectant comprising a cls gene suppressor exhibited reduced biofilm formation onto a solid surface.

In some embodiments, the disinfectant is applied onto a surface. Any surface can be treated by the disinfectant. Examples of types of surfaces that may be treated by the disinfectant include, but are not limited to, food processing equipment surfaces such as tanks, conveyors, floors, drains, coolers, freezers, equipment surfaces, walls, valves, belts, pipes, joints, crevasses, combinations thereof, and the like. The surfaces can be metal, for example, aluminum, steel, stainless steel, chrome, titanium, iron, alloys thereof, and the like. The surfaces can also be plastic, for example, polyolefins (e.g., polyethylene, polypropylene, polystyrene, poly(meth)acrylate, acrylonitrile, butadiene, ABS, acrylonitrile butadiene, etc.), polyester (e.g., polyethylene terephthalate, etc.), and polyamide (e.g., nylon), combinations thereof, and the like. The surfaces may also be brick, tile, ceramic, porcelain, wood, vinyl, linoleum, or carpet, combinations thereof, and the like. The surfaces may also, in other aspects, be food, for example, beef, poultry, pork, vegetables, fruits, seafood, combinations thereof, and the like.

For disinfection and sterilization of hard surfaces, the disinfectant may be applied to the hard surface directly from a container in which the disinfectant solution is stored. For example, the disinfectant solution can be poured, sprayed or otherwise directly applied to the hard surface. The disinfectant solution can then be distributed over the hard surface using a suitable substrate such as, for example, cloth, fabric, or paper towel. Alternatively, the disinfectant may first be applied to a substrate such as cloth, fabric or paper towel. The wetted substrate can then be contacted with the hard surface. Alternatively, the disinfectant solution can be applied to hard surfaces by dispersing the solution into the air.

### Product

In some embodiments, the present invention provides a method for producing a product, comprising pasteurized food product or beverage, wherein the method comprises the steps of: pretreating a food product suspected of containing bacteria by contacting a food product with an effective amount of the agent, to obtain a pretreated food article; and pasteurizing the pretreated food article, to obtain a pasteurized food article.

In some embodiments, the present invention provides a method for producing a disinfected product, comprising contacting the product suspected of containing bacteria with an effective amount of the agent as described herein; and heat-treating the product, to obtain a disinfected product article.

In some embodiments, the product (e.g., disinfected product or pasteurized food or beverage) is characterized by less than 1 colony forming unit (CFU)/milliliter. In some embodiments, the product is characterized by less than 10 colony forming units (CFU)/milliliter. In some embodiments, the product is characterized by less than 100 colony forming units (CFU)/milliliter. In some embodiments, the product is characterized by less than 1000 colony forming units (CFU)/milliliter. In some embodiments, the product (e.g., disinfected product or pasteurized food or beverage) is characterized by less than 100.000 CFU /milliliter, less than 10.000 CFU/milliliter, less than 1000 CFU/milliliter, less than 1000 CFU/milliliter, less than 1000 CFU/milliliter, less than 500 CFU/milliliter, less than 300 CFU/milliliter, less than 100 CFU/milliliter, less than 50 CFU/milliliter, less than 10 CFU/milliliter, less than 5 CFU/milliliter, including nay range or value therebetween.

Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

As used herein, the term “reducing” in any grammatic form thereof, is related to reduction (e.g. of enzymatic or transcription activity) by at least 20%, at least 30%, at least 40%, at least 50%, at least 60%, at least 70%, at least 80%, at least 90%, including any value therebetween.

As used herein, the term “inhibiting” in any grammatic form thereof, is related to reduction (e.g. of enzymatic or transcription activity) by at least 80%, at least 90%, at least 95%, at least 97%, at least 98%, at least 99%, at least 99.9%, including any value therebetween.

In some embodiments, the term “inhibiting” in any grammatic form thereof, comprises a complete arrest of activity (e.g. enzymatic or transcription activity). In some embodiments, the term “inhibiting” and the term “silencing” are used herein interchangeably.

Other terms as used herein are meant to be defined by their well-known meanings in the art.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### Composition

In some embodiments, the invention is directed to a composition comprising an effective amount of the agent, and an acceptable carrier and/or diluent. A person with skill in the art will appreciate that the effective amount may differ between different types of liquids and selected applications.

The composition may still further contain components which enhance or promote uptake of the active ingredient by bacterial cells. These may include, for example, chemical agents which generally promote a cellular uptake of RNA and/or DNA.

In some embodiments, the composition also includes incorporation of the active ingredient into or onto particulate preparations of polymeric compounds such as polylactic acid, polyglycolic acid, hydrogels, etc., or onto liposomes, microemulsions, micelles, unilamellar or multilamellar vesicles, erythrocyte ghosts, or spheroplasts. Such composition will influence the physical state, solubility, stability and rate of release.

As used herein, the term “carrier” refers to a diluent, adjuvant, excipient, or vehicle with which the active ingredient is administered. Such carriers are known in the art and include, for example, semi-solid or liquid diluents, fillers and formulation auxiliaries of all kinds. The carrier typically will be liquid, but also can be solid, or a combination of liquid and solid components.

As used herein, the terms “administering”, “administration”, and like terms refer to any method which, in sound medical practice, delivers a composition containing an active agent to a subject in such a manner as to provide a therapeutic effect.

Compositions containing the presently described agents as the active ingredient can be prepared according to conventional pharmaceutical compounding techniques. See, for example, Remington: The Science and Practice of Pharmacy, 22^{nd} Ed., Pharmaceutical Press, Philadelphia, Pa. (2012).

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### EXAMPLES

Generally, the nomenclature used herein, and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988); Watson et al., “Recombinant DNA”, Scientific American Books, New York; Birren et al. (eds.) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N.Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, Conn. (1994); Mishell and Shiigi (eds), “Strategies for Protein Purification and Characterization—A Laboratory Course Manual” CSHL Press (1996); all of which are incorporated by reference. Other general references are provided throughout this document.

### Materials and Methods

### Bacterial Strains

Following Bacillus subtilis NCIB3610 strain and its derivatives were used (Table 1).

TABLE 1
Bacterial strains used herein.

| | Strain | Genotype | Strain description |
|---|---|---|---|
| Bacillus | NCIB3610 | wildtype (WT) | Undomesticated WT strain |
| subtilis | | | |
| Bacillus | YC189 | P_{tapA}-cfp in | Produces cyan fluorescent |
| subtilis | | 3610, Spec^{R} | protein (CFP) under the |
| | | | control of tapA promoter |
| Bacillus | ΔclsA | ΔclsA-Erm^{R} | Knockout mutant of clsA on |
| subtilis | | | the background of NCIB3610 |
| Bacillus | ΔclsB | ΔclsB-Erm^{R} | Knockout mutant of clsB on |
| subtilis | | | the background of NCIB3610 |

In order to create knockout mutants of clsA and clsB, ΔclsA and ΔclsB mutants on the background of 168 Bacillus subtilis strain (BKE36590 and BKE37190 respectively) were ordered from the Bacillus Genetic Stock Center. Next, the mutants were transformed to the Bacillus subtilis NCIB 3610 strain through traditional transduction.

### Biofilm Formation

Three kinds of biofilms were tested—colony type, pellicle and bundles. For colony type—bacteria were grown in LB medium for 5h and then 3-5 μl of the culture were spotted on an LB-GM (1% tryptone, 0.5% yeast extract, 0.5% NaCl, 1% glycerol, 0.1 mM MnSO₄ and 2% agar) (Difco) or modified MRS (MMRS—MRS pH 7) (Man, Rogosa & Sharpe) (Hy-labs) plates. Once the spotted drops were soaked into the medium, the plates were incubated upside down at 30° C. for 72 h. For pellicle biofilm formation 24-well plates were used. Bacteria were grown in LB medium for 5 h and then the culture was diluted 1:1000 into MMRS. Next, plates were incubated at 30° C., 20 rpm for 48 h. For the experiments with supplementation of CL, 0-100 μM CL dissolved in chloroform was added (final concentration of chloroform was 0.2%). For bundle type biofilm, a starter culture was prepared using a single bacterial colony inoculated into 5 ml of LB medium overnight at 30° C., 150 rpm. Next, bacteria were diluted 1:100 into fresh MMRS at 37° C., 25 rpm and after 5-7 h a 1 ml sample was taken and washed twice with sterile water. For longer incubation times, a starter culture was prepared using a single bacterial colony inoculated into 3 ml of LB medium for 5 h at 37° C., 150 rpm. Next, bacteria were diluted 1:100 into fresh MMRS at 23° C., 25 rpm overnight. The samples were visualized by fluorescence microscopy.

### Fluorescence Microscopy

For visualization of bundle type biofilm a 1 ml sample was taken and washed twice with sterile water. Next Nonyl Acridine Orange (NAO) (Invitrogen A1372) was added to a final concentration of 100 nM for a 20 minutes incubation at room temperature. Next 3-7 μl from each sample were loaded on a microscopy glass slide. The samples were visualized using a fluorescent microscope in a transmitted light microscope using differential interference contrast (DIC) and 426-450 nm laser for CFP excitation (for visualization of YC189) or 457 nm-487 nm laser for GFP excitation (for visualization of NAO stained samples) (Nikon Eclipse Ti2).

### Heat Sensitivity Analysis

The survival rate of the different strains was tested as follows. Prior to generating starter cultures, B. subtilis were grown on agar-solidified plates overnight, at 37° C. A starter culture was prepared using a single bacterial colony inoculated into 5 ml of LB medium overnight at 30° C., 150 rpm. Next, bacteria were diluted 1:100 into fresh LB at 37° C., 25rpm and after 5-7 h a 3 ml sample was taken and incubated at 60-63° C. for 30 minutes. Next, bacteria were kept on ice for 2 minutes and mildly sonicated for 20 s—amplitude, 20%; pulse, 10 s; pause, 10 s—with the Ultrasonic processor (Sonics, Newtown, USA). The number of surviving cells after heat treatment was quantified by the CFU method, i.e., serial dilutions from each sample were prepared, spread-plated on LB agar and incubated overnight at 37° C., and colonies were counted.

### Real-Time PCR

For RNA purification, a starter culture was prepared using a single bacterial colony inoculated into 5 ml of LB medium overnight at 30° C. Next, bacteria were diluted 1:100 into fresh MMRS at 37° C., 50 rpm and after 3-5 h a 2-3 ml sample was harvested. The RNA was purified using PureLink™ RNA Mini Kit (ThermoFisher Scientific) following the manufacturer's protocol RNA concentration was measured with a Nanodrop 2000 spectrophotometer (ThermoFisher Scientific). cDNA was synthesized from 1 μg RNA in reverse transcription reaction using High-Capacity RNA-to-cDNA™ Kit (ThermoFisher Scientific) following the manufacturer's instructions. All cDNA samples were diluted 1:100 and stored at −20° C. For RT-PCR reactions Fast SYBR® Green Master Mix kit was used. Samples were prepared according to manufacturer's protocol.

Forward and reverse PCR primers were designed using the Primer express software and were synthesized by hy-labs (Rehovot, Israel). DNA was amplified with the Applied Biosystems StepOne™ Real-Time PCR System (Life technologies, Foster, Calif., USA) under the following PCR conditions: denaturation 2 min at 95° C. and 40 cycles of 95° C. for 3 s, 60° C. for 30 s, and 95° C. for 15 s. RNA samples without reverse transcriptase were used as negative control, to determine there is no DNA contamination. The expression levels of the tested genes tasA, epsH) was relatively calculated using 16SrRNA and rpoB genes as endogenous control.

TABLE 2
Primers used for RT-PCR

| | | SEQ |
|---|---|---|
| | | ID |
| Name | Primer | NO. |
| 16srRNA | F 5′GCGAAGTGCGGGTGATTT 3′ | 1 |
| | R 5′GCAGTCTATGTGTGTTTACCGTTACCT 3′ | 2 |
| rpoB | F 5′ TGCCGGTTACGGTTCTTTTG 3′ | 3 |
| | R 5′ TGTCGCTGTTTTCTGTGTTATCTTTAT3′ | 4 |
| tasA | F 5′ TCTAATGGCGCTTAATTATGGAGAT 3′ | 5 |
| | R 5′ CAACTGTCAACAATGTCACTTCAAAC 3′ | 6 |
| epsH | F 5′AACGCCGCTCTATCATTATCG 3′ | 7 |
| | R 5′AGCGCAAGTCCTGATTVAAAC 3′ | 8 |
| clsA | F 5′ GTTCTTTTCTTTATTCCCGTTTTAGG 3′ | 9 |
| | R 5′ CCGGTCTTCCCATTGAAACA 3′ | 10 |
| clsB | F 5′ CAGCAAGGGACTATTTCTCACAAG 3′ | 11 |
| | R 5′ AAGCGGTTTTGATGGAATGTAATAA 3′ | 12 |

### Example 1

### Creation of ΔclsA and ΔclsB Mutants

The membrane lipid composition of Bacillus subtilis is highly variable, and changes according to the state in which the bacteria are in. Among these lipids is the cardiolipin (CL) which makes up to 25% of the membrane composition. CL is a unique phospholipid as it consists of four hydrophobic alkyl groups and carries two negative charges, in opposite to regular phospholipids, comprising two hydrophobic tails and one hydrophilic head group. These characteristics make CL an important structural and functional unit in the bacterial membrane. It was previously shown, that in the presence of, the ability of is reduced. The inventors presumed, that the reduced ability of Bacillus subtilis cells to form biofilm upon exposure to Mg²⁺ ions, could be a result of electrostatic interactions between the Mg²⁺ ions and membranal cardiolipin. These interactions would result in membrane rearrangements, thus limiting the ability of Bacillus subtilis cells to form biofilm.

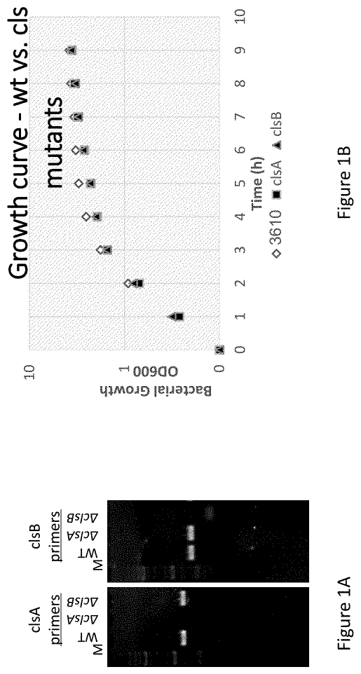

The inventors, therefore, wanted to test the influence of deletion of Bacillus subtilis cardiolipin synthases (cls) on biofilm production. Bacillus subtilis contains two cardiolipin synthases—the major form—clsA (also called ywnE) which is expressed during vegetative growth and the minor form clsB (also called ywjE) which is involved in sporulation. Mutants were created as described herein (Materials and Methods). The deletions were verified through PCR (FIG. 1A). Next, the inventors confirmed that there is no growth delay in the mutant strains (FIG. 1B).

### Example 2

### Evaluation of the Sensitivity of ΔclsA to Heat Treatment

The inventors assumed that the inability of Bacillus subtilis cells, that were supplemented with Mg²⁺ ions, to form biofilm was due to the interaction of these ions with CL. Hence, if these bacteria lacked CL in their membrane, one would expect that the bacterial membrane would be constantly affected, thus reducing the ability of the mutant strains to survive heat treatment.

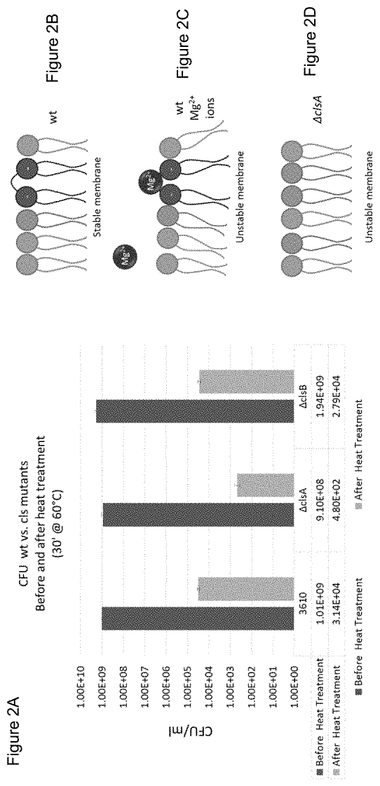

In order to test whether the lack of CL influences bacterial resistance to heat treatment, the inventors compared the survivability of the wt (wild type) and the mutant strains after 30 minutes at 60° C. According to FIG. 2A, ΔclsA is most sensitive to heat treatment, and the survival of ΔclsB seems to resemble the survival of the wt strain. The higher survival rate of the ΔclsB mutant could be explained by the presence of clsA, which is the major CL-synthase. It is conceivable, that in presence of clsA, enough CL is synthesized, resulting in improved membrane stability and enhancing bacterial resistance to heat treatments. Thus, the inventors concluded that lack of CL in the membrane causes the bacteria to be more sensitive to heat treatments (FIG. 2A, FIG. 2D). The sensitivity observed in the wt strains in the presence of Mg²⁺ ions, could be explained by direct interaction between the Mg²⁺ ions and membrane CL, causing a conformational change in the CL resulting in destabilization of the membrane (FIG. 2C).

### Example 3

### Evaluation of Biofilm Formation by ΔclsA and ΔclsB Mutants

Next, the inventors wanted to test if the mutants can form biofilm. To this end, three different types of biofilms which are formed by Bacillus subtilis were analyzed: (i) colony type, which is formed in the interface between solid and air; (ii) pellicle, which is formed in the interface between liquid and air; and (iii) bundles, which are formed in a liquid medium. As shown in FIG. 3, the mutant strains do not form biofilm in any of the conditions tested. These results show that both forms of cardiolipin synthase are required and influence the ability to form biofilm. This strengthens the dependence of the ability to form biofilm on the presence of CL. According to this, the presence of CL is crucial for the capability of producing biofilm regardless of the growth stage in which the bacteria are in—the vegetative stage (ΔclsA) or the sporulation stage (ΔclsB).

Taken together, the Mg²⁺ ions seem to have the same effect on the wt membrane as the absence of CL in the cls mutants—in both cases the bacteria are more sensitive to heat treatments and biofilm is not formed. CL seems to stabilize the membrane and in case of its absence and/or destabilization by Mg²⁺ ions, the bacteria become more vulnerable. Stable CL is important for biofilm formation either as a structural unit or a mediator which directs and/or enables bacteria to enter the biofilm pathway.

### Example 4

### Analysis of the Expression of Matrix Producing Genes in the cls Mutants

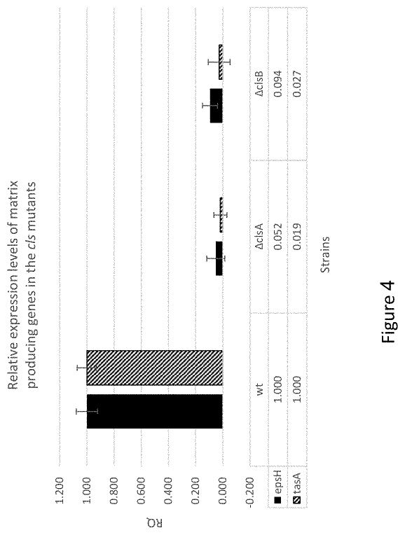

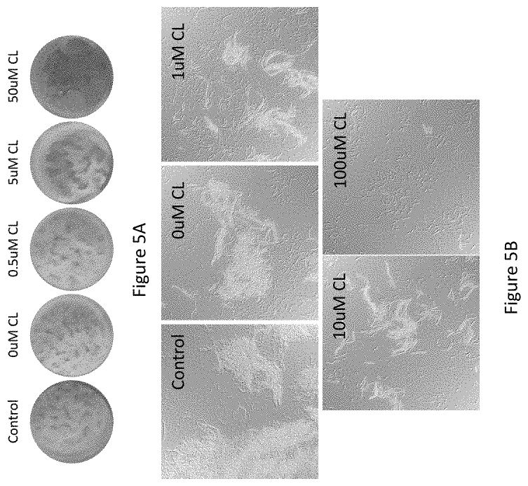

In order to understand whether the inhibition of biofilm production is due to inhibition in the expression levels of the matrix producing genes, the inventors analyzed the expression pattern of the matrix producing genes tasA (taking part in production and assembly of an amyloid-like fibers) and epsH (taking part in production of exopolysaccharides) in comparison with their expression in the wt strain. 16s and rpoH served as endogenous controls. According to FIG. 4, the expression levels of tasA and epsH are dramatically decreased in the clsA and clsB mutants (a ˜50 and ˜35 fold reduction for tasA; a ˜20 and ˜10 fold reduction for epsH, respectively) compared to the wt strain. These results explain the phenotype of the cls mutants, which do not produce biofilm.

### Example 5

Extracellular Cardiolipin Interferes with Normal Biofilm Formation

In order to test whether cardiolipin (CL) could possibly rescue the biofilm phenotype of the mutants, the inventors added 10-fold serial dilutions of CL to the medium. The CL was not able to rescue the mutants' phenotype (not shown), however, surprising, in high concentrations, it delayed biofilm formation in YC189 strain of Bacillus subtilis. As shown in FIG. 5A, after 18 hours, there is a delay in pellicle biofilm formation at 5-50 μM concentration of CL (CL at a concentration of 50 μM reduced biofilm formation 18 h post treatment). In B. subtilis, biofilm formation depends on synthesis of extracellular matrix, whose production is specified by two major operons: the epsA-O and tapA-sipW-tasA operons. The tapA operon for production and assembly of amyloid-like fibers. Inventors tested how the addition of CL influences the tapA promoter by using the YC189 strain which harbors a gene coding to CFP under the control of the tapA promoter (P_{tapA}-cfp). After 12 h, at CL concentrations of 10 μM and of 100 μM, the tapA operon is not stimulated and biofilm is not formed (FIG. 5B). While after 18 h, the bacteria start to overcome even the high concentrations of CL and bundles start to form (FIG. 5C). However, even after 18 h at CL concentration of 10 μM, the biofilm formation is substantially reduced. Surfactin is a cyclic lipopetide secreted by B. subtilis. It indirectly activates the membrane histidine kinase KinC that phosphorylates Spo0A, which eventually triggers a subpopulation of cells to produce the extracellular matrix. It is speculated, that the added CL molecules might titrate away the surfactin secreted from the bacteria, so that the biofilm is not formed until higher amounts of surfactin are secreted after longer periods of time. Based on the results on this experiment and on the results described in the Example 3, the inventors concluded that the treatment of bacteria (e.g. B. subtilis) by CL may induced or enhance bacterial heat-susceptibility. In some embodiments, treatment is at the concentration described herein.

### Example 6

### Combined Effect of Cardiolipin and Surfactin on Biofilm Formation

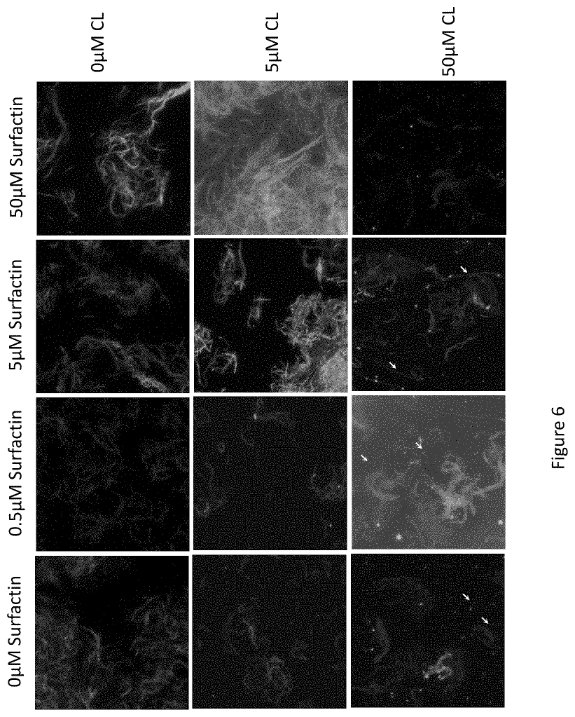

B. subtilis (WT 3610) was grown for 5 h at 37° C., 150 rpm according to the conditions described above. Then 2 μl of bacteria were added to 1 ml LBG accompanied by solutions with different concentrations of CL and surfactin. After about 20 h the samples were stained with NAO (according to the protocol described herein), which was added to the unwashed samples. Finally, the samples were washed after the staining and the pellicle formation was tested. The results of this experiment are summarized in FIG. 6, representing substantial reduction of biofilm formation upon combined treatment with CL and surfactin (e.g. at a concentration of 50 μM of both agents).

As shown in FIG. 6, at high concentrations of CL (50 μM) string-like structures connecting the bacteria have been observed (see white arrows). In the sample of high concentrations of CL as well as surfactin these strings are missing.

Based on the results on this experiment and on the results described in the Example 3, the inventors concluded that the treatment of bacteria (e.g. B. subtilis) by a combination of CL and surfactin may induce or enhance bacterial heat-susceptibility. In some embodiments, treatment is at the concentration described herein. In some embodiments, the ratio of CL to surfactin is as described herein.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for sensitizing bacteria to heat treatment, comprising contacting said bacteria with an effective amount of an agent selected from the group consisting of cardiolipin (CL), a cardiolipin synthase (cls) inhibitor, and a cls gene suppressor, or any combination thereof, thereby producing heat-sensitive bacteria.

2. The method of claim 1, wherein said cls inhibitor is selected from the group consisting of: distearoylphosphatidate, dimyristoylphosphatidate, (trans-,trans)dioleoylphosphatidate, and dipalmitoylphosphatidate.

3. The method of claim 1, wherein said cls gene suppressor is selected from the group consisting of: an exogenous DNA sequence, a small RNA, a steric block antisense oligonucleotide, a CRISPR/Cas9, and an aptamer, or any combination thereof.

4. The method of claim 1, wherein said agent is a metal salt comprising a metal selected from the group consisting of barium, cobalt, copper, iron, nickel, manganese, zinc, and strontium or any combination thereof.

5. The method of claim 1, to wherein said contacting comprises contacting bacteria with a solution comprising an effective concentration of said agent.

6. The method of claim 1, further comprising the step of heat-treating said composition, thereby reducing the bacterial load of said composition.

7. The method of claim 1, further comprising the step of heat-treating said composition, thereby substantially preventing biofilm formation.

8. The method of claim 1, wherein said reducing is reducing the bacterial load by at least a factor of 10, as compared to a non-treated composition.

9. A method for pasteurizing a food or beverage product, comprising the steps of:
contacting said product with an effective amount of an agent, wherein said agent is selected from the group consisting of: cardiolipin (CL), surfactin, a cls inhibitor, a cls gene suppressor and a divalent metal cation selected from the group consisting of: barium, cobalt, copper, iron, nickel, manganese, zinc, and strontium or any combination thereof;
pasteurizing said product, thereby producing a pasteurized food productor beverage.

10. The method claim 1, wherein said bacteria are of the genus Bacillus.

11. A composition for enhancing bacterial heat susceptibility, the composition comprising an agent selected from cardiolipin (CL), a cardiolipin synthase (cls) inhibitor, and a cls gene suppressor or any combination thereof.

12. The composition of claim 11, wherein said cls inhibitor is selected from the group consisting of: distearoylphosphatidate, dimyristoylphosphatidate, (trans-,trans)dioleoylphosphatidate, and dipalmitoylphosphatidate.

13. The composition of claim 11, wherein said cls gene suppressor is selected from the group consisting of: an exogenous DNA sequence, a small RNA, a steric block antisense oligonucleotide, a CRISPR/Cas9, and an aptamer, or any combination thereof.

14. The composition of claim 11, wherein said agent comprises a metal salt, wherein said metal is selected from the group consisting of barium, cobalt, copper, iron, nickel, manganese, zinc, and strontium or any combination thereof.
